(19) United States
(12) Patent Application Publication
(10) Pub. No.: US 2018/0246740 A1
(43) Pub. Date: Aug. 30, 2018

(54) OPERATION SUPPORT SYSTEM, INFORMATION PROVIDING APPARATUS, AND MACHINE

(71) Applicant: Koichiro Maemura, Kanagawa (JP)

(72) Inventor: Koichiro Maemura, Kanagawa (JP)

(21) Appl. No.: 15/904,470

(22) Filed: Feb. 26, 2018

(30) Foreign Application Priority Data
Feb. 27, 2017 (JP) 2017-035013

(51) Int. Cl. G06F 9/451; G06F 3/12

(52) U.S. Cl. CPC G06F 9/453; G06F 3/1256; G06F 3/1205

(57) ABSTRACT

An operation support system for supporting operations performable on a machine includes circuitry to receive, from the machine, an operation support request for the machine, and information of display items and display status of the display items displayed on a display of the machine, store a plurality of operation support information for supporting the operations performable on the machine in a memory, the operation support information to be determined by the information of the display items and the display status of the display items, select at least one operation support information from the memory based on the information of the display items and the display status of the display items received from the machine, and generate screen information of an operation support screen to be displayed on the display of the machine by using the selected at least one operation support information.

### CROSS-REFERENCE TO RELATED APPLICATION

This application claims priority pursuant to 35 U.S.C. § 119(a) to Japanese Patent Application No. 2017-035013, filed on Feb. 27, 2017, in the Japan Patent Office, the disclosure of which is incorporated by reference herein in its entirety.

### BACKGROUND

### Technical Field

This disclosure relates to an operation support system, an information providing apparatus, a machine.

### Background

When users are puzzled how to operate electronic apparatuses such as printers or a multi-function peripherals (MFPs), the users can use an assist function such as a help function that assists or supports the users to solve problems on operations.

The help function can be configured by, for example, a help server connected to the electronic apparatus wirelessly or by wire, in which the electronic apparatus can acquire information on operations of the electronic apparatus from the help server to generate information (i.e., help information) for solving the problems and display the help information as a help screen on a display of the electronic apparatus. The information on operations of the electronic apparatus includes, for example, information of countermeasures to solve failures occurring in the electronic apparatus, and information of methods of implementing desired operations.

Further, the help function can be configured by, for example, a camera-mounted portable terminal connected to the help server via a network, in which the camera captures an image of an internal mechanism of the electronic apparatus, the help server acquires the image of the internal mechanism of the electronic apparatus from the camera, the electronic apparatus acquires the corresponding help information from the help server, and then generates the help information and the image as one integrated information to display the one integrated information on the display of the electronic apparatus.

However, since conventional help function configures the help information with a hierarchical structure setting a large number of menus in a given order, the user needs to search the hierarchy of the large number of menus by himself or herself, which is not easy for the user to find appropriate information.

### SUMMARY

In one aspect of the present invention, an operation support system for supporting one or more operations performable on a machine is devised. The operation support system includes circuitry to receive, from the machine, an operation support request for the machine, and information of one or more display items and display status of the one or more display items displayed on a display of the machine, store a plurality of operation support information for supporting the one or more operations performable on the machine in a memory, the operation support information to be determined by the information of the one or more display items and the display status of the one or more display items, select at least one operation support information from the memory based on the information of the one or more display items and the display status of the one or more display items received from the machine, and generate screen information of an operation support screen to be displayed on the display of the machine by using the selected at least one operation support information.

In another aspect of the present invention, an information providing apparatus for providing information supporting one or more operations performable on a machine disposed in an operation support system is devised. The information providing apparatus includes a memory to store a plurality of operation support information for supporting one or more operations performable on the machine, the operation support information settable in view of information of one or more display items and display status of the one or more display items, and circuitry to receive, from the machine, an operation support request for the machine, and information of one or more display items and display status of the one or more display items displayed on a display of the machine, select at least one operation support information from the memory based on the information of the one or more display items and the display status of the one or more display items received from the machine, and generate screen information of an operation support screen to be displayed on the display of the machine by using the selected at least one operation support information.

In another aspect of the present invention, a machine disposed in an operation support system is devised. The machine includes circuitry to transmit an operation support request for the machine, and information of one or more display items and display status of the one or more display items displayed on a display of the machine to an information providing apparatus that is configured to provide information to the machine, receive, from the information providing apparatus, screen information of an operation support screen, which is generated in the information providing apparatus based on at least one operation support information used for supporting one or more operations performable on the machine, the at least one operation support information is selected based on the information of the one or more display items and the display status of the one or more display items at the information providing apparatus, acquire setting contents, related to the one or more display items and the display status of the one or more display items, set in the machine using the at least one operation support information included in the screen information of the operation support screen, and update the screen information of the operation support screen displayed on the display of the machine based on the acquired setting contents.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 illustrates an example of a schematic configuration of an operation support system;

FIG. 2 illustrates an example of a hardware configuration of an electronic apparatus such as a multi-functional peripheral (MFP) used in the operation support system of FIG. 1;

FIG. 3 illustrates an example of a hardware configuration of an information providing apparatus such as a help server used in the operation support system of FIG. 1;

FIG. 4 illustrates an example of a functional block diagram of the electronic apparatus of FIG. 2;

FIG. 5 illustrates an example of a functional block diagram of the information providing apparatus of FIG. 3;

FIG. 6 illustrates an example of a functional block diagram of an information terminal used in the operation support system of FIG. 1;

FIG. 7 illustrates an example of a sequence diagram of processing until a help screen is displayed;

FIG. 8 illustrates an example of a sequence diagram of processing when a help item is selected;

FIG. 9 illustrates an example of a sequence diagram of processing of changing settings in a help screen and closing the help screen;

FIG. 10 illustrates an example of a sequence diagram of processing of closing a help screen without changing settings;

FIG. 11 illustrates an example of a help data table stored in the information providing apparatus;

FIG. 12 illustrates an example of a screen before a help screen is opened;

FIG. 13 illustrates an example of a help screen when the help screen is opened;

FIG. 14 illustrates an example of a help screen when the help item is selected;

FIG. 15 illustrates an example of a screen after changing settings in a help screen and closing the help screen;

FIG. 16 illustrates an example of a sequence diagram of processing of referring to utilization status of help screen;

FIG. 17 illustrates an example of a help screen utilization status contents; and

FIG. 18 illustrates another example of a help screen utilization status contents.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

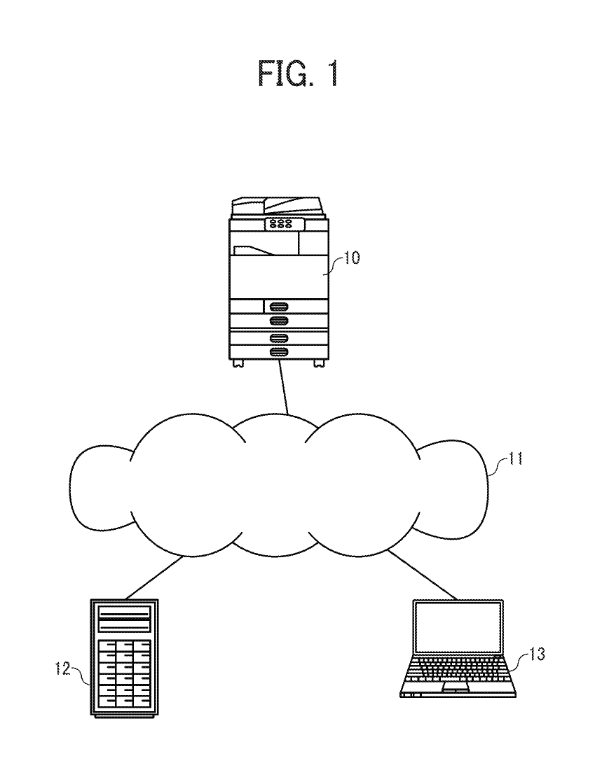

FIG. 1 illustrates an example of a system configuration of an operation support system used for supporting one or more operations performable on an electronic apparatus. The operation support system illustrated in FIG. 1 includes, for example, an electronic apparatus, an information providing apparatus, and an information terminal. The electronic apparatus can be any apparatus having a display, and the electronic apparatus may be, for example, a printer, a multi-functional peripheral (MFP), a copier, a facsimile machine, a scanner, and the like. Hereinafter, the electronic apparatus is exemplified as a multi-functional peripheral (MFP) 10 having a plurality of functions such as a scanner function, a copying function, a facsimile function, and a printing function. In this description, the electronic apparatus such as MFP 10 that can perform printing and others is described as an example of machines that can perform various operations.

As illustrated in FIG. 1, the MFP 10 is connected to a network 11 such as a local area network (LAN) and/or a wide area network (WAN), and communicates with other apparatuses connected to the network 11 via the network 11. The network 11 may be a wired network, a wireless network, or a combination of wired and wireless network. Further, the network 11 is not limited to one single network, but can be configured with two or more networks connected by a relay device such as a router or a proxy server. Further, the network 11 may include a communication restriction unit, which is provided to the relay device, such as a firewall that restricts information communication.

When a user is to use a specific function of the MFP 10 but the user does not know how to use the specific function of the MFP 10, the user requests an operation support for the specific function, in which the MFP 10 acquires screen information of an operation support screen as operation support information, and displays the operation support screen on an operation unit (e.g., operation panel) of the MFP 10. The screen information of the operation support screen includes, for example, a help screen information. The help screen information includes information used for solving one or more problems that has occurred in the MFP 10 and one or more methods of setting information for implementing one or more desired operations. Hereinafter, the help screen is described as an example of the operation support screen, and the help screen information is described as an example of the screen information of the operation support screen.

When the MFP 10 acquires the help screen information, and the MFP 10 displays the help screen on the operation unit such as an operation panel based on the acquired help screen information. Then, a user using the MFP 10 can refer to the help screen displayed on the operation unit of the MFP 10, and perform an operation by following instructions indicated by the information displayed on the help screen.

In this description, the information providing apparatus can be any information providing apparatus capable of providing information requested by the MFP 10, and the information providing apparatus is exemplified as a help server 12 that provides the above mentioned help screen information. Hereinafter, the help server 12 is described as an example of the information providing apparatus.

The help server 12 is connected to the network 11, and stores a plurality of data such as help contents to be used to generate the help screen information. When the help server 12 receives a request from the MFP 10 via the network 11, the help server 12 generates the help screen information corresponding to the request using at least one of the help contents, and then provides the help screen information to the MFP 10 via the network 11.

The help server 12 also stores information of a utilization status of the help screen. When the help server 12 receives a request for referring the utilization status information from a requesting apparatus such as the MFP 10, the help server 12 provides the utilization status information to the requesting apparatus. The utilization status information indicates a utilized frequency of the help screen, wherein information of the utilized frequency of the help screen can be generated when one help item is selected from one or more help items included in the help screen. The greater the utilized frequency of a specific help screen, the more useful the specific help screen for the user of the MFP 10. The utilized frequency of the help screen is also referred to as a referred frequency indicating the number of times of referencing one or more operation support screens (e.g., help screens) displayed on the MFP 10 in response to an operation support request for the operation support screen. When the help server 12 receives an acquisition request of the referred frequency of the operation support screen, the help server 12 provides the referred frequency of each of the plurality of the operation support screens stored in the memory to the machine such as MFP 10.

In this description, the information terminal 13 may be, for example, a smartphone, a tablet terminal, a notebook personal computer (PC) or the like. The information terminal 13 is connected to the network 11 wirelessly and/or by wire, and communicates with the MFP 10 and the help server 12 via the network 11. The information terminal 13 communicates with the help server 12 to acquire information of the utilization status of the help screen from the help server 12, and displays the utilization status information. A user such as an administrator of the system can use the information terminal 13 to check which help screen is used frequently and useful by referring the displayed utilization status information. Further, the administrator can also check which help screen is not used frequently and not so useful by referring the displayed utilization status information. In this configuration, the user such as the administrator can delete and/or modify information that is not so useful.

The operation support system illustrated in FIG. 1 includes each of the apparatuses for one, but not limited thereto. For example, the MFP 10 can be two or more, the help server 12 can be two or more, and the information terminal 13 can be two or more. The operation support system can further include other apparatuses such as a print server and a contents server. The MFP 10, the help server 12, and the information terminal 13 can be connected to the network 11 by wire such as cables, or can be connected to the network 11 wirelessly. When the MFP 10, the help server 12, and the information terminal 13 are connected to the network 11 wirelessly, one or more access points connected to the network 11 can be used.

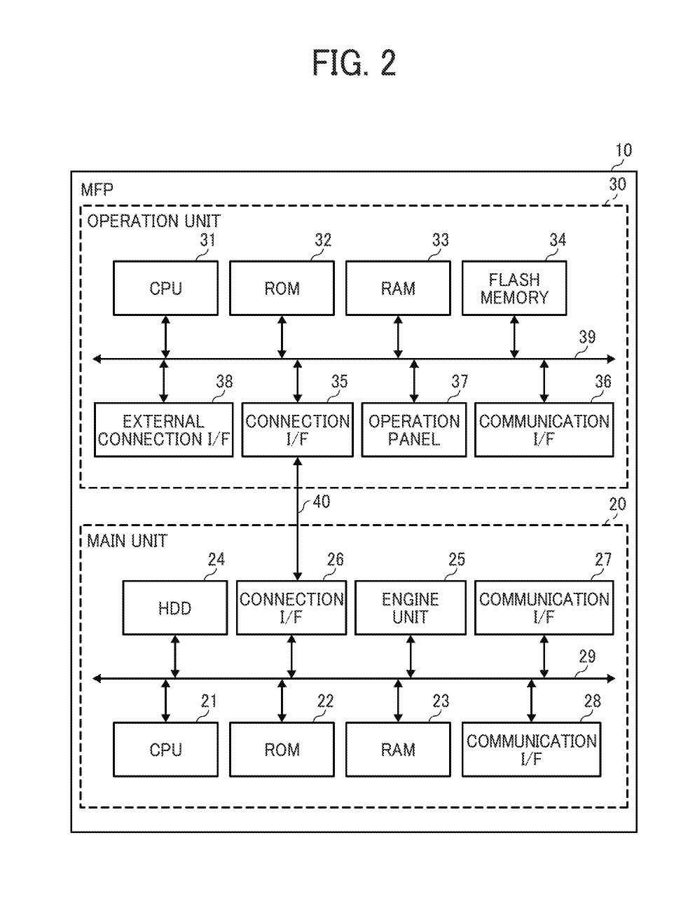

A description is given of a hardware configuration of the MFP 10 with reference to FIG. 2. As illustrated in FIG. 2, the MFP 10 includes, for example, a main unit 20, and an operation unit 30. The main unit 20 implements various functions such as a copying function, a scanner function, a facsimile function, and a printing function while the operation unit 30 receives an input corresponding to an operation performed by a user. The main unit 20 and the operation unit 30 may be connected with each other via a dedicated communication line 40. The communication line 40 can use, for example, universal serial bus (USB) standard, but the communication line 40 can use any standard regardless of whether the standard is wired or wireless.

The main unit 20 can perform one or more operations corresponding to one or more input information received by the operation unit 30. Further, the main unit 20 can also communicate with other apparatuses such as the information terminal 13, and can perform one or more operations in response to one or more instructions received from the information terminal 13.

The main unit 20 includes, for example, a central processing unit (CPU) 21, a read only memory (ROM) 22, a random access memory (RAM) 23, a hard disk drive (HDD) 24, an engine unit 25, a connection interface (I/F) 26, and communication interfaces (I/F) 27 and 28, which are connected to each other via a bus 29.

The CPU 21 controls the operation of the main unit 20 entirely. The CPU 21 uses the RAM 23 as a working area, executes one or more programs stored in the ROM 22 and the HDD 24 to control the operation of the main unit 20, and implements the above described various functions. In addition to the above-described programs, the HDD 24 can store data such as document data and various settings.

The engine unit 25 executes processing other than general information processing and communication to implement the above described various functions. For example, the engine unit 25 includes a scanner (image scanning unit) for scanning an image of a document, a plotter (image forming unit) for printing an image on a sheet material such as paper, and a facsimile communication unit for performing facsimile communication, and the like. The engine unit 25 may further include optional units such as a finisher for finishing printed sheets, and an automatic document feeder (ADF) for automatically conveying document, and the like.

The connection I/F 26 is used as an interface for communicating with the operation unit 30 via the communication line 40. The communication I/F 27 is used as an interface to transmit a request for acquiring the help screen information to the help server 12 via the network 11, and to receive the help screen information from the help server 12. The communication I/F 28 is used as an interface to call a telephone or perform a fax communication via a public communication network different from the network 11.

The operation unit 30 includes, for example, a CPU 31, a ROM 32, a RAM 33, a flash memory 34, a connection I/F 35, a communication I/F 36, an operation panel 37, and an external connection I/F 38, which are connected to each other via a bus 39.

The CPU 31 controls operations of the operation unit 30 entirely. The CPU 31 uses the RAM 33 as a working area, executes one or more programs stored in the ROM 32 and the flash memory 34 to control operations of the operation unit 30, and implements various functions. The functions of the operation unit 30 include, for example, displaying setting contents, switching a display of information, receiving input information, and receiving a selection of information.

The connection I/F 35 is used as an interface for communicating with the main unit 20 via the communication line 40. The communication I/F 36 is used as an interface for communicating data such as transmitting and receiving data through the network 11. The operation panel 37 receives an information input, and displays information. In this example, the operation panel 37 employs a liquid crystal display device composed of a liquid crystal display (LCD) equipped with a touch panel function, but not limited thereto. The operation panel 37 can employ, for example, an organic electro-luminescence (OEL) display equipped with a touch panel function. Further, in addition to the operation panel 37 or instead of the operation panel 37, a display unit such as a hardware key and a lamp can be provided.

The external connection I/F 38 can be connected to an integrated circuit (IC) card reader and the like. When the IC card reader is connected to the external connection I/F 38, user information stored in the IC card can be read, with which a user authentication function can be implemented. The external connection I/F 38 can be connected to an external storage apparatus such as an external HDD or other apparatuses.

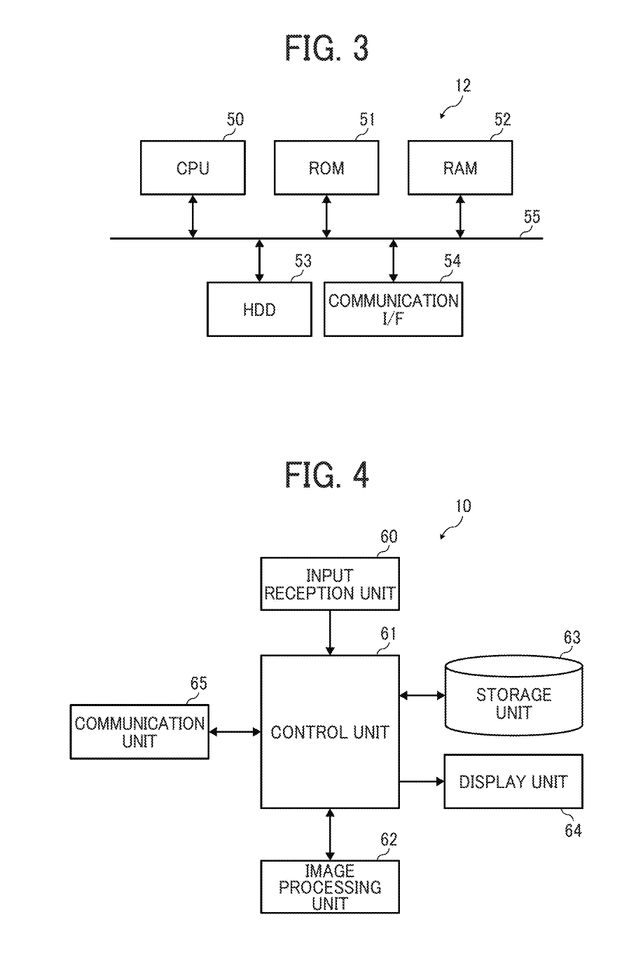

A description is given of a hardware configuration of the help server 12 with reference to FIG. 3. As illustrated in FIG. 3, the help server 12 includes, for example, a CPU 50, a ROM 51, a RAM 52, HDD 53, a communication I/F 54, and a bus 55. The help server 12 can further include other hardware devises such as an input/output I/F, a display device, and an input device.

The CPU 50 executes one or more programs stored in the ROM 51 and the HDD 53 to control the operations of the help server 12 entirely. The ROM 51 is a non-volatile memory that stores a basic input output system (BIOS) and various settings to be executed at the time of startup or activation of the help server 12. The RAM 52 is a volatile memory for providing a working area that loads one or more programs read out and executed by the CPU 50. The HDD 53 is a non-volatile memory for storing an operating system (OS), various programs, and various data. In this configuration, the HDD 53 is used as the memory, but not limited thereto. For example, a solid state drive (SSD) or the like can be used as the memory.

The communication I/F 54 is used as a network interface for connecting the help server 12 to the network 11, and communicating with the MFP 10 and the information terminal 13 connected to the network 11. The bus 55 is connected to the CPU 50, the ROM 51, and the like, and is used to transmit an address signal, a data signal, and various control signals.

The input/output I/F is used as an interface for controlling the outputting of information to a display device, and the inputting of the information from an input device. The display device is, for example, a liquid crystal display and an organic electro-luminescence (OEL) display, and displays the contents of notification transmitted from the MFP 10 and the information terminal 13. The input device is, for example, a mouse and a keyboard that receives information input by a user.

Although the information terminal 13 is not described in detail, the information terminal 13 can be configured in the same manner as the help server 12 by additionally including the above mentioned input/output I/F, the display device, and the input device. A description is given of a functional configuration of the MFP 10, the help server 12, and the information terminal 13 with reference to FIGS. 4 to 6.

FIG. 4 illustrates an example of a functional block diagram of the MFP 10. The MFP 10 can generate and implement a plurality of functional units by executing one or more programs stored in a memory such as the flash memory 34 by using the CPU 31 of the operation unit 30. In this example case, the CPU 31 generates the plurality of functional units by executing the one or more programs, but not limited to thereto. For example, the MFP 10 can employ hardware resources such as an integrated circuit to implement a part or all of the plurality of functional units.

As illustrated in FIG. 4, the MFP 10 includes, for example, an input reception unit 60, a control unit 61, an image processing unit 62, a storage unit 63, a display unit 64, and a communication unit 65 as the functional units.

The input reception unit 60 receives various operation and/or information from a user. For example, the input reception unit 60 receives user operations such as setting the setting contents of the MFP 10, instructions for executing the image processing, a request for displaying the help screen, a selection of help item in the help screen, and a change of the setting contents of the MFP 10. The display unit 64 displays information received by the input reception unit 60, processing status of the image processing, the status of the apparatus, and the help screen. The display of the help screen can be performed using software for browsing information called as a browser that can be executed in the MFP 10.

The control unit 61 controls the MFP 10, in which the control unit 61 changes the setting contents, instructs the image processing unit 62 to perform the image processing, instructs the display unit 64 to display information, instructs the communication unit 65 to transmit and receive information, uses the storage unit 63 to write information to the storage unit 63 and reads the information from the storage unit 63. Therefore, the control unit 61 can function as various units such as a change unit, an instruction unit, a writing unit, a reading unit, and the like.

When the input reception unit 60 receives a request for displaying the help screen, the control unit 61 acquires model information of the MFP 10, screen information of a currently-displayed screen, one or more display items displayed in the screen, and information of a display status of the one or more display items. Then, the control unit 61 instructs the communication unit 65 to transmit the model information and required information to the help server 12 together with the request for acquiring the help screen information. Further, the control unit 61 transmits the help screen information received by the communication unit 65 to the display unit 64, and instructs the display unit 64 to display the help screen.

The image processing unit 62 executes the image processing such as scanning of document, copying of document, printing of document, and the like after receiving the instruction from the control unit 61. The storage unit 63 stores various settings necessary for the image processing as setting data. After receiving an instruction from the control unit 61, the communication unit 65 requests the help server 12 to acquire the help screen information via the network 11, and receives the help screen information from the help server 12. The communication unit 65 receives an execution request of the image processing from the information terminal 13, and also receives an instruction from the control unit 61, and notifies a user that the image processing has been completed.

The control unit 61 refers to the help screen information to acquire setting data related to the model information set in the MFP 10 from the storage unit 63, and updates the help screen information based on the acquired setting data. Therefore, the control unit 61 can function as an acquiring unit for acquiring the setting data, and updating unit for updating the help screen information. Further, the communication unit 65 can function as a transmitting unit and a receiving unit as described above.

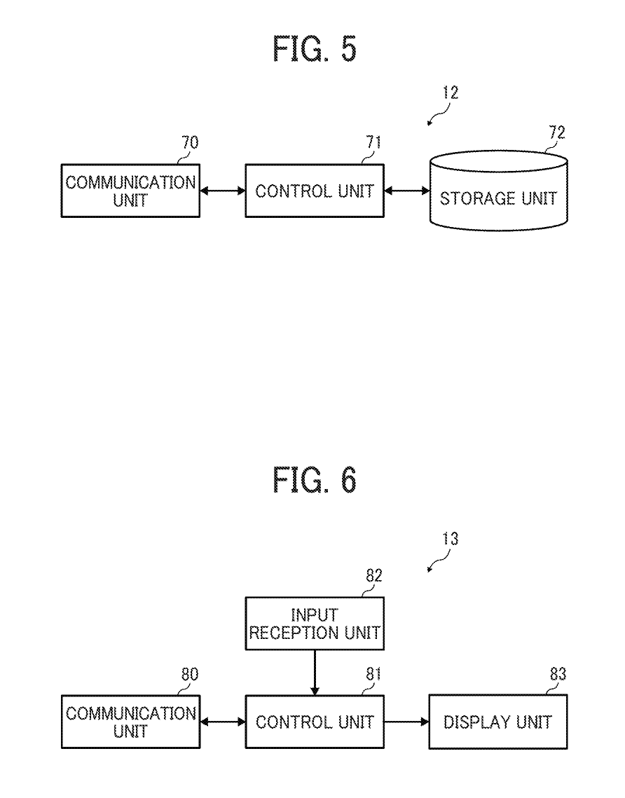

FIG. 5 illustrates an example of a functional block diagram of the help server 12. Similar to the MFP 10, the help server 12 can generate and implement a plurality of functional units by executing one or more programs stored in a storage device such as the HDD 53 in the same manner of the MFP 10. The help server 12 can also employ hardware resources such as an integrated circuit to implement a part or all of the plurality of functional units.

The help server 12 includes, for example, a communication unit 70, a control unit 71, and a storage unit 72. After the communication unit 70 receives a request for acquiring the help information from the MFP 10, the communication unit 70 receives the above-mentioned model information from the MFP 10. Then, the communication unit 70 receives an instruction from the control unit 71, and transmits the help screen information to the MFP 10. In this configuration, the communication unit 70 can function as a transmitting unit and a receiving unit. The help screen information is used to display the help screen.

The storage unit 72 stores the model information, the screen information, the display items, the help contents corresponding to the display status, and information of the utilization status of the help screen requested by a user. In this configuration, the storage unit 72 is illustrated as one storage unit, but not limited thereto. The storage unit 72 can be configured with a plurality of storage units such as one storage unit storing the help content and another storage unit storing information of the utilization status.

The control unit 71 receives a request for acquiring the help screen information from the MFP 10, and selects at least one help contents necessary for generating the help screen information based on the received model information and the like.

The control unit 71 configures the help screen by arranging the help items in a sequential order that is likely to be useful for a user by using the selected help contents, with which the help screen information is generated. Then, the control unit 71 instructs the communication unit 70 to transmit the generated help screen information. Therefore, the control unit 71 can function as a selection unit, a generation unit, and a determination unit for determining the display order of the help items.

The help server 12 can implement, for example, HyperText Transfer Protocol (HTTP) server function, and can receive the request from the MFP 10 as an HTTP request, and provide the help screen information to the MFP 10 as a response to the HTTP request. Further, the help server 12 can provide information of the utilization status of the help screen to the information terminal 13 as a response to a request from the information terminal 13. This information providing can be also performed by the communication unit 70.

FIG. 6 illustrates an example of a functional block diagram of the information terminal 13. Similar to the MFP 10 and the help server 12, the information terminal 13 can generate and implement a plurality of functional units by executing one or more programs stored in a storage device such as a flash memory or a HDD. The information terminal 13 can also employ hardware resources such as an integrated circuit to implement a part or all of the plurality of functional units.

As illustrated in FIG. 6, the information terminal 13 includes, for example, a communication unit 80, a control unit 81, an input reception unit 82, and a display unit 83.

The input reception unit 82 receives a request for acquiring information of the utilization status of the help screen from a user. When the control unit 81 receives the acquisition request of the information of the utilization status of the help screen, the control unit 81 instructs the communication unit 80 to acquire the utilization status information. When the communication unit 80 receives the instruction from the control unit 81, the communication unit 80 transmits a request for acquiring information of the utilization status to the help server 12.

The communication unit 80 receives information of the utilization status from the help server 12. The control unit 81 instructs the display unit 83 to display information of the utilization status acquired by the communication unit 80. When the display unit 83 receives the instruction from the control unit 81, the display unit 83 displays the information of the utilization status. As to the information terminal 13, the control unit 81 can function as an instruction unit, and the communication unit 80 can function as a transmitting unit and a receiving unit.

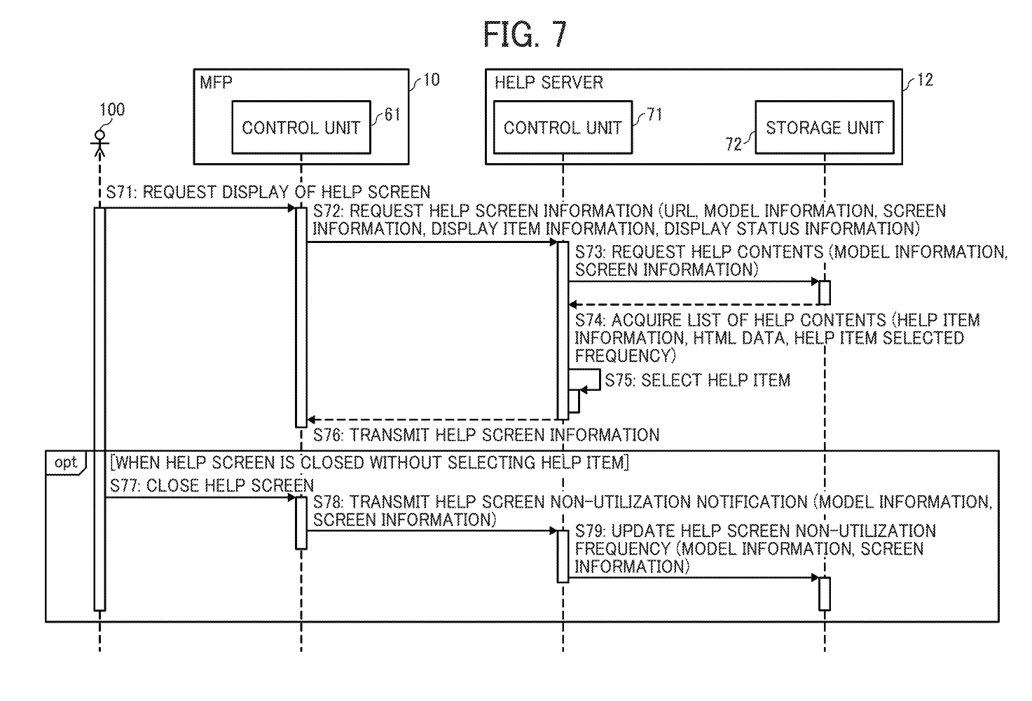

A description is given of a sequence when a user requests for displaying the help screen, the MFP 10 acquires the help screen information from the help server 12, and then displays the help screen with reference to FIG. 7.

First, a user 100 operates the MFP 10 to cause the MFP 10 to scan, copy, print, or fax a document. When the user cannot choose a specific menu on the screen or the user are puzzled how to operate a specific screen in the middle of operating the MFP 10, and the user cannot continue the desired operation, the user presses a help button set in the display screen (S71 in FIG. 7) to request a display of the help screen.

After the control unit 61 of the MFP 10 receives the request for displaying the help screen via the input reception unit 60, the control unit 61 requests the help server 12 to acquire the help screen information from the help server 12 via the communication unit 65 (S72 in FIG. 7). At this stage, the control unit 61 can request the acquiring of the help screen information by using uniform resource locator (URL). Further, the control unit 61 also acquires the model information, the screen information, the display items information, and the display status information of the MFP 10, and transmits these information to the help server 12.

The model information is information indicating a type of the apparatus, and the screen information is information specifying a currently displayed screen. The display item is an item displayed in the currently displayed screen, and the display status is information indicating whether the display item is displayed as a selectable item or non-selectable item.

The control unit 71 of the help server 12 acquires a request and various information from the MFP 10 through the communication unit 70. The control unit 71 requests the storage unit 72 to acquire the help contents based on the model information and the screen information (S73 in FIG. 7).

Then, the control unit 71 acquires a list of help contents from the storage unit 72 (S74 in FIG. 7). The list of help contents includes, for example, the help item information, HTML data as the help contents, and information indicating a frequency of selecting the help item (i.e., the number of times of selecting the help item), which is to be referred to as help-item-selected frequency in this description. The help-item-selected frequency corresponds to the number of times of selecting and referencing the help item, which is also referred to as a referred count. The referred count indicates the number of times of selecting and referencing each of operation support items such as the help items included in the operation support screen.

During the processing of S73 and S74, the control unit 71 updates a help screen requested frequency, which is the number of times of requesting the acquisition of the help screen information, and the storage unit 72 stores the updated help screen requested frequency, the model information, and the screen information by associating the updated help screen requested frequency, the model information, with which the degree of utilization of help screen and usefulness/effectiveness of help screen can be verified based on the information stored in storage unit 72.

Then, the control unit 71 selects a required help item from the acquired list of the help contents (S75 in FIG. 7). The control unit 71 selects necessary help content based on the acquired display item information and display status information, and identifies one or more help items required for displaying the help screen from the selected help contents.

Then, based on the acquired help-item-selected frequency, the control unit 71 generates the help screen information by configuring the help screen by rearranging the help items in a descending order of selection frequency (i.e., from higher to lower selection frequency) based on the acquired help-item-selected frequency, and transmits the help screen information to the MFP 10 (S76 in FIG. 7). The control unit 61 of the MFP 10 acquires the help screen information via the communication unit 65, and instructs the display unit 64 to display the help screen on the display.

Thereafter, when the user 100 closes the help screen without selecting any one of the help items (S77 in FIG. 7), the concerned help screen may be useless for the user 100 with a higher probability so that the control unit 61 of the MFP 10 transmits a help screen non-utilization notification to the help server 12 via the communication unit 65 (S78 in FIG. 7). The help screen non-utilization notification indicates that the concerned help screen is not utilized, and includes the model information and the screen information.

Then, when the control unit 71 of the help server 12 receives the help screen non-utilization notification via the communication unit 70, the control unit 71 associates the help screen non-utilization frequency with the model information and the screen information, and stores the help screen non-utilization frequency with the model information and the screen information in the storage unit 72 (S79 in FIG. 7). When the help screen non-utilization frequency is already stored in the storage unit 72, the help screen non-utilization frequency is counted up to update the help screen non-utilization frequency.

In this configuration, after operating the MFP 10 for a certain period of time, data such as the help screen non-utilization frequency and the help screen requested frequency can be stored in the storage unit 72, and then analyzed to extract the help screen that was not used effectively. Then, the data can be used for identifying one or more targets that may require improvement.

In an example case illustrated in FIG. 7, the user 100 closes the help screen without selecting any help item.

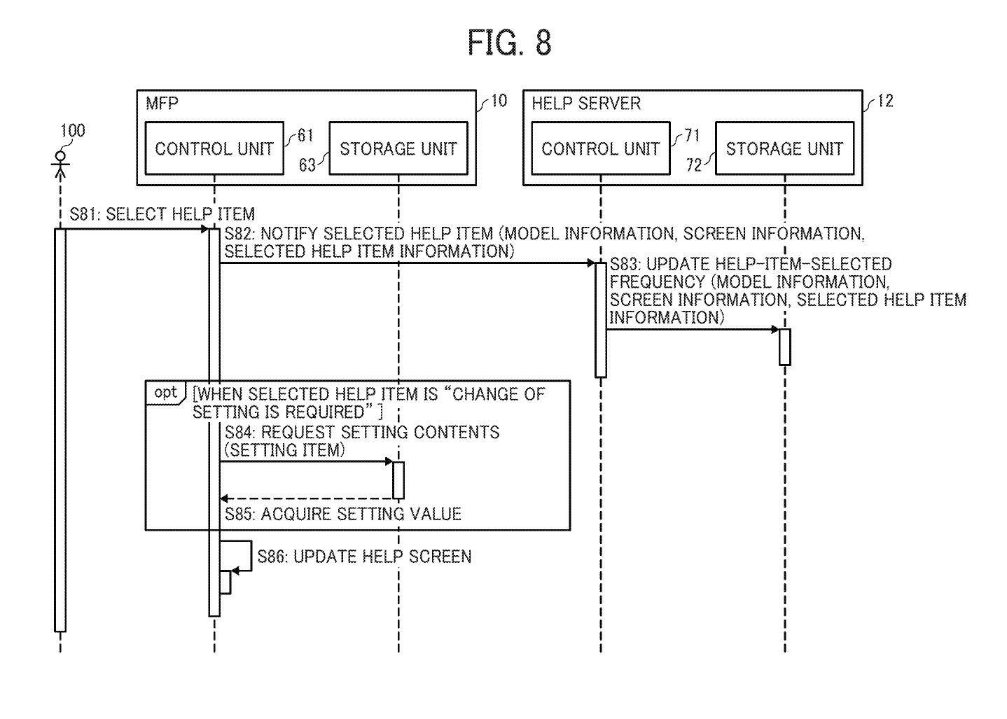

Hereinafter, a description is given of processing when the help item is selected with reference to FIG. 8. First, the user 100 selects one of the help items in the help screen displayed by using the display unit 64 of the MFP 10 (S81 in FIG. 8).

Then, the control unit 61 of the MFP 10 receives information of the selected help item via the input reception unit 60, and notifies the information of the selected help item to the help server 12 via the communication unit 65 (S82 in FIG. 8). The notification includes information of the selected help item, the model information of the MFP 10, and the screen information of the currently displayed screen on the MFP 10.

Then, the control unit 71 of the help server 12 receives the above-mentioned notification via the communication unit 70, counts up the help-item-selected frequency stored in the storage unit 72 to update the help-item-selected frequency (S83 in FIG. 8). The help-item-selected frequency is stored in the storage unit 72 in association with the model information and the screen information, in which the to-be-updated help-item-selected frequency is specified or identified based on the model information and the screen information included in the notification.

When the sequence illustrated in FIG. 7 is performed, the MFP 10 receives the help screen information from the help server 12, and the control unit 61 temporarily stores the help screen information. The help screen information includes one or more help contents that are required to display the help screen. When the help content corresponding to the selected help item indicates “change of setting is required,” the control unit 61 requests the storage unit 63 to acquire the setting contents in response to the instruction included in the help content (S84 in FIG. 8). The request for the setting contents can include a setting item corresponding to a setting value that is requested for acquiring.

The control unit 61 acquires the setting value corresponding to the setting item included in the above-mentioned request from the storage unit 63 (S85 in FIG. 8).

Then, the control unit 61 updates the help screen based on the setting status of the apparatus (i.e., acquired setting value) (S86 in FIG. 8).

In this configuration, the MFP 10 acquires the setting contents from the storage unit 63 disposed in the MFP 10, and updates the help screen based on the acquired setting contents, in which a sequence that the help server 12 acquires the setting contents through a firewall, updates the help screen information, and provides the information to the MFP 10 is not required. For example, when changing the setting contents, an access right may be required, and personal information such as user information is required to determine whether a user has the access right. By contrast, in the above-described configuration of the embodiment, since the personal information is not leaked to the network 11, information security can be secured.

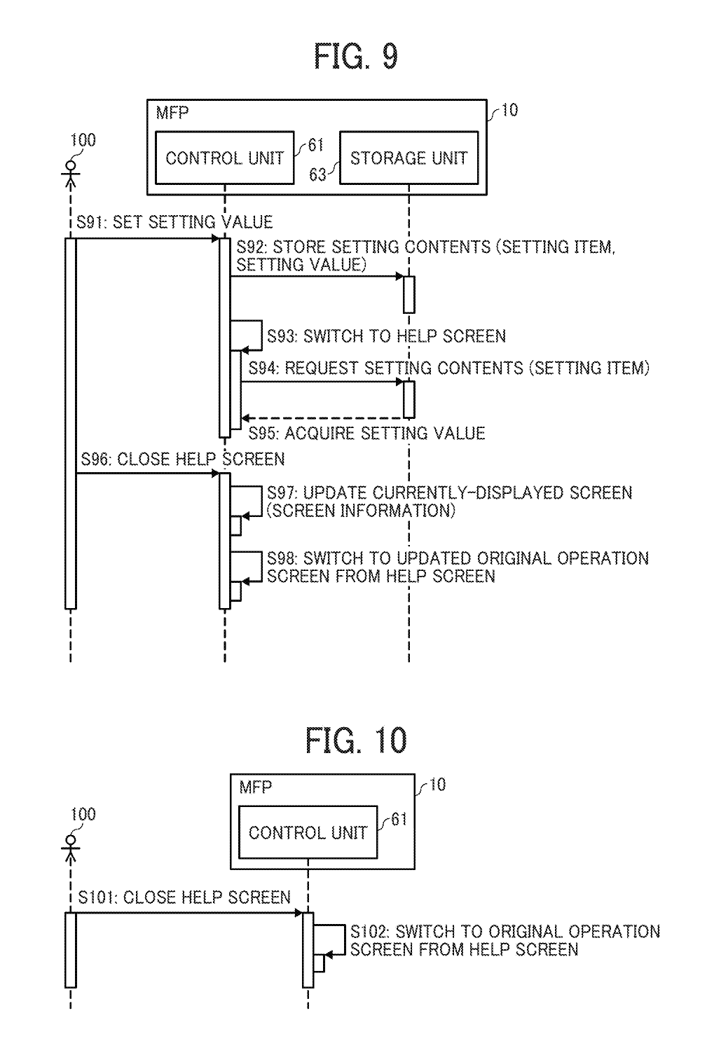

A description is given of a process of changing settings in an updated help screen and closing the help screen with reference to FIG. 9. In the sequence of FIG. 9, the user 100 selects or inputs a setting value in the updated help screen, and requests the MFP 10 to apply the setting value (S91 in FIG. 9).

Then, the control unit 61 of the MFP 10 receives the request via the input reception unit 60, and the control unit 61 requests the storage unit 63 to store the setting contents (S92 in FIG. 9). The request for storing the setting contents includes, for example, a setting item and a setting value. The storage unit 63 stores the setting item and the setting value by associating the setting item and the setting value with each other.

Then, the control unit 61 switches to a help screen that is displayed by using the display unit 64 (S93 in FIG. 9). Then, the control unit 61 requests the storage unit 63 to acquire the setting contents (S94 in FIG. 9), and acquires the setting value as the setting contents from the storage unit 63 (S95 in FIG. 9), in which the setting value is a value that is changed by performing the setting change processing.

Since the help item is selected in the sequence of FIG. 9, it is assumed that the processing such as the above described help screen non-utilization notification is not executed in the sequence of FIG. 9, but it is assumed that the help screen is utilized, and the help-item-selected frequency is updated in the sequence of FIG. 9.

When the user 100 performs the setting change in the help screen, and confirms the change, the user 100 closes the help screen (S96 in FIG. 9). The closing of the help screen can be performed by pressing a “close” button in the help screen by the user 100.

In this example case, since the setting change is performed in the help screen, a display status of one or more display items in the currently-displayed screen may be changed. Therefore, a process of updating the currently-displayed screen is performed (S97 in FIG. 9). For example, the display screen is updated by changing the display status of a specific display item from a non-selectable status to a selectable status by performing the setting change.

Thereafter, the control unit 61 switches the help screen displayed by using the display unit 64 to the updated original operation screen (S98 in FIG. 9). With this configuration, before closing the help screen, a change can be set to the operation screen hiding under the help screen, and then the updated or changed operation screen can be displayed after closing the help screen.

In an example case of FIG. 9, the process of changing the settings in the updated help screen is described. Hereinafter, a description is given of a process of closing a help screen without changing the settings with reference to FIG. 10. If the setting change is not performed, the processing of steps S91 to S96 of FIG. 9 such as applying the setting value, storing the setting contents, and switching of the help screen are not required.

In the sequence of FIG. 10, the user 100 closes the help screen (S101 in FIG. 10). The closing of the help screen can be performed by pressing the “close” button in the help screen as described above. In this case, the setting change is not performed in the help screen but the help item is selected in the help screen. Therefore, it is assumed that the processing such as the above described help screen non-utilization notification is not executed, but it is assumed that the help screen is utilized, and the help-item-selected frequency is updated.

After closing the help screen, the control unit 61 switches the help screen to the original operation screen, which is the screen before opening the help screen (S102 in FIG. 10 S102). That is, the help screen is closed to display the original operation screen hiding under the help screen. In this example case, since the setting change is not performed, the display status of the display items in the displayed screen does not change, in which the screen is not required to be updated, and thereby the screen is immediately switched to the original operation screen.

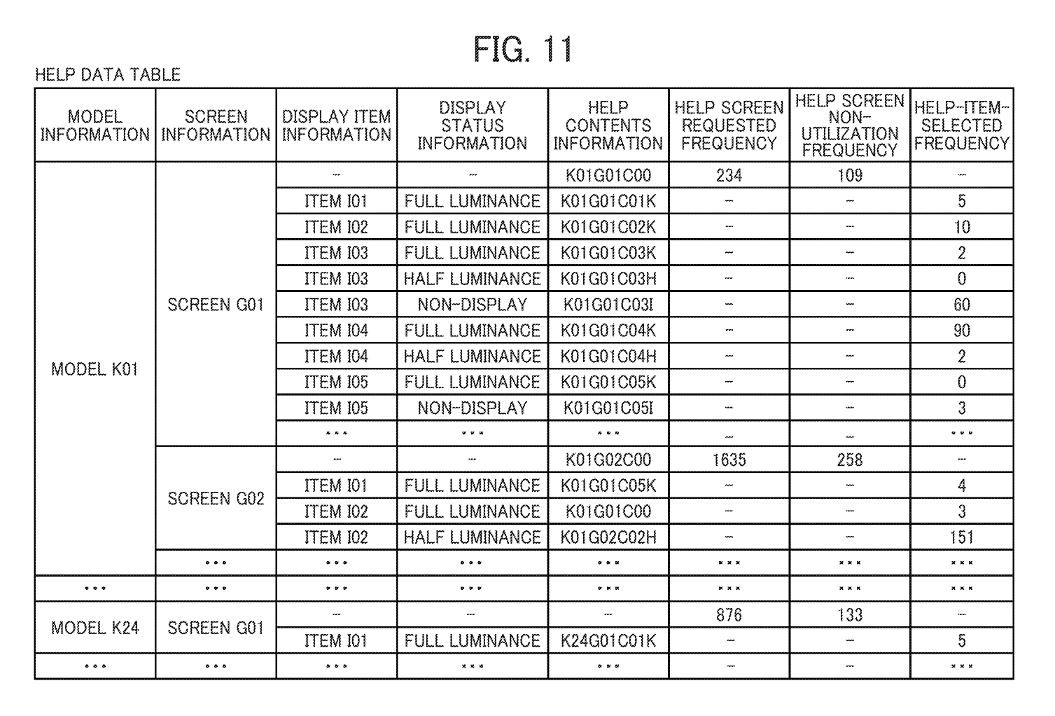

Hereinafter, a description is given of data stored in the storage unit 72 of the help server 12 with reference to FIG. 11. FIG. 11 illustrates an example of a help data table storing various data such as the help screen requested frequency, the help screen non-utilization frequency, and the help-item-selected frequency. As illustrated in FIG. 11, the help data table includes, for example, the model information, screen information, display item information, display status information, help contents information for specifying help contents, help screen requested frequency, help screen non-utilization frequency, and help-item-selected frequency.

As illustrated in FIG. 11, each of the model information is associated with one or more screen information, and each of the screen information is associated with information of one or more display items. Further, each display item is associated with one display status, and one help contents information specifying the help contents. The help contents information specifying the help contents is used as contents identification information. The help contents includes, for example, contents information configuring a part of a Web page such as hypertext markup language (HTML), JavaScript (registered trademark), and cascading style sheets (CSS). Each of the screen information can be further associated with the contents identification information of the help contents used for displaying an outer frame layout of the entire help screen of a target screen.

As to different models and screens, the help contents may become different contents information for each of the models and screens, but the same contents information can be set for the different models and the different screens. For example, as illustrated in FIG. 11, the help contents information of “K01G01C05K” is used for two screens such as “screen G01” and “screen G02,” which means the same contents information can be used even if the models and the screens are different.

After receiving the request for acquiring the help screen information from the MFP 10, the help server 12 selects one or more help items based on the received model information, screen information, display item information, and display status information. Then, the help server 12 arranges the selected one or more help items in a given order of the help-item-selected frequency such as the descending order of the help-item-selected frequency to configure a help screen, and transmits the help screen information to the MFP 10.

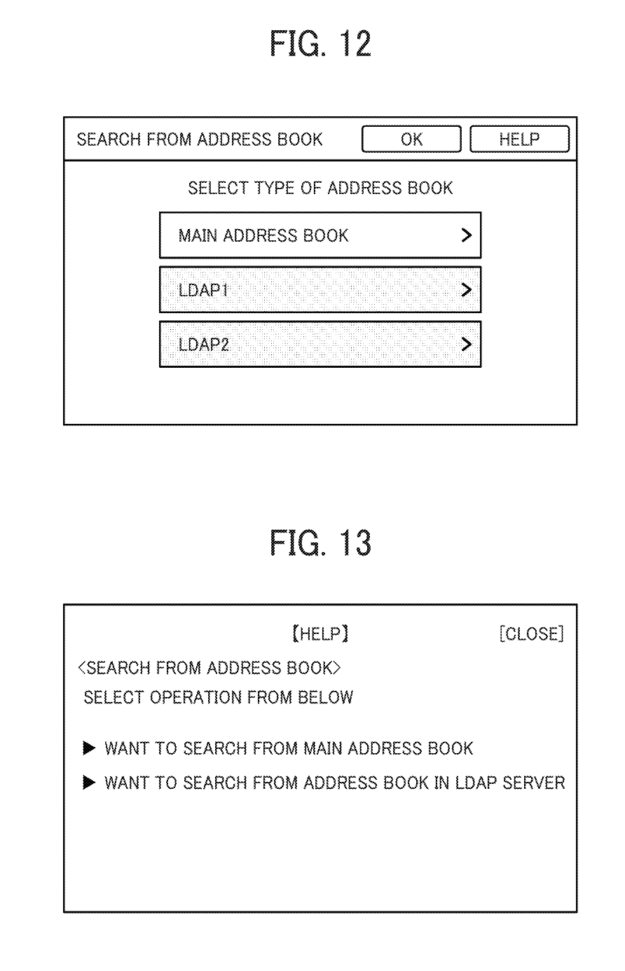

Hereinafter, a description is given of how the screen transits when the above described processing is performed with reference to an example screen displayed on the MFP 10. FIG. 12 illustrates an example of a screen before the help screen is opened. The screen illustrated in FIG. 12 is a screen for “search from address book,” in which the screen is used to search an address of a transmission destination.

In this example case, the screen displays three items such as “main address book,” “LDAP1” and “LDAP2” as the display items. The “main address book” indicates an address book stored in the MFP 10, the “LDAP1” indicates an address book stored in a LDAP1 server, and the “LDAP2” indicates an address book stored in a LDAP2 server. The display status indicates whether the display item is selectable or not selectable. In this example screen (FIG. 12), the “main address book” is displayed with full luminance indicating the selectable item, and the “LDAP1” and “LDAP2” are displayed with half-luminance indicating the non-selectable item. The full luminance display is a display with a constant luminance (normal luminance), and the half-luminance display is a dimmed display that lowers the luminance compared to the full luminance display.

As to the screen illustrated in FIG. 12, the current setting contents indicates that the “main address book” is alone displayed with the full luminance, in which the “main address book” is set as the selectable item. Therefore, if a user is to search an address from the “main address book,” the user can press an “OK” button to execute the searching.

By contrast, if the user wants to search an address from the LDAP server such as the LDAP1 and LDAP2, the user cannot search an address from the LDAP server because the LDAP server is displayed with the half-luminance display indicating the LDAP server is not selectable in the current setting contents. In this case, the user can press a “Help” button to open the help screen so that the user can search an address from the LDAP server.

FIG. 13 illustrates an example of a help screen when the help screen is opened by pressing the “Help” button (see FIG. 12). In this example case, the “screen G02” (see FIG. 11) is used as the screen information of the “address book search” screen illustrated in FIG. 12, an “item 101” (see FIG. 11) is set as “main address book,” and an “item 102” (see FIG. 11) is set as “LDAP,” in which the LDAP indicates LDAP1 and/or LDAP2.

The help screen includes a help item corresponding to the display item. In this example case, the help screen displays a help item of “want to search from main address book” and another help item of “want to search from address book from LDAP server.” In this example case, the help screen sets the help contents “K01G02C00” of the screen information of “screen G02” (see FIG. 11) as the contents information for displaying the outer frame of the entire help screen, and displays the help contents “K01G01C05K” corresponding to the “item I01” as the help item of “want to search from main address book,” and the help contents “K01G01C05K” includes the contents information used for performing various displays after the help item is selected. Further, the help screen displays the help contents “K01G02C02H” corresponding to the “item 102” as the help item of “want to search from address book from LDAP server,” and the help contents “K01G02C02H” includes the contents information used for performing various displays after the help item is selected.

Further, the “item 102” is associated with the contents information of “K01G02C02K.” Since the currently-displayed screen displays “LDAP1” and “LDAP2” with the half-luminance, the contents information of “K01G02C02K is not selected.

Therefore, when the user presses the “Help” button and requests the display of the help screen, the help server 12 configures the help screen using the help contents of “K01G02C00,” “K01G01C05K,” and “K01G02C02H”, and provides the help screen information to the MFP 10. The MFP 10 downloads the help screen information from the help server 12, and displays the help screen based on the downloaded help screen information.

As illustrated in FIG. 13, the help screen includes a “close” button. When the “close” button is pressed, the currently-displayed help screen is closed, and then the screen is returned to the original operation screen such as “search from address book”.

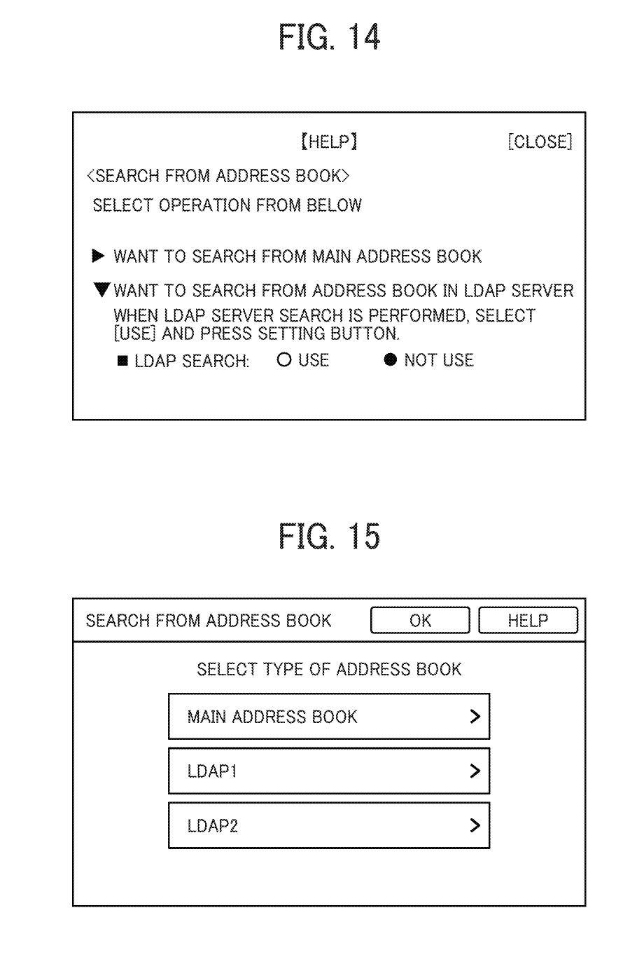

FIG. 14 illustrates an example of the help screen that is displayed when “want to search from address book in LDAP server” is pressed in FIG. 13. When the user presses “want to search from address book in LDAP server” in FIG. 13, the selected help item is notified, and the help-item-selected frequency illustrated in FIG. 11 is counted up.

To check the reason why LDAP1 and LDAP2 cannot be selected on the screen, the setting contents is acquired as illustrated in FIG. 8, and the help screen that prompts the valid setting of LDAP search is displayed. For example, the help contents “K01G02C02H” of the selected help item describes which setting contents is required to be acquired, and how the currently-displayed screen is switched to what help screen including what help item based on the acquired setting contents.

In an example illustrated in FIG. 14, the help screen displays the current setting contents that sets “not use” for the search from the LDAP server (i.e., LDAP search) and a radio button of “use.” Therefore, the help screen of FIG. 14 can be used to prompt a user to select the radio button of “use” and press the “setting” button to activate the LDAP search. In an example illustrated in FIG. 14, the radio button is used, but other display style such as a check box can be used.

When the number of times selecting “want to search from address book in LDAP server” is increased by counting up of the help-item-selected frequency, and then the number of times selecting “want to search from address book in LDAP server” exceeds the number of times selecting “want to search from main address book,” the help screen arranges “want to search from address book in LDAP server” at the top position, and “want to search from main address book” at the next position, which is an order opposite to the order illustrated in FIG. 13.

FIG. 15 illustrates an example of the original operation screen of “search from address book” after the help screen is closed by selecting the “use” in the help screen illustrated in FIG. 14 and then pressing the “setting” button. The original operation screen of “search from address book” hiding under the help screen of FIG. 14 is updated before closing the help screen of FIG. 14, and then the updated original operation screen is displayed as illustrated in FIG. 15.

In the screen illustrated in FIG. 15, “LDAP1” and “LDAP2” are also displayed with the full luminance display indicating the LDAP server is selectable so that the LDAP search can be performed by selecting any one of “LDAP1” and “LDAP2.” With this configuration, the problem that the LDAP search cannot be performed can be appropriately and simply solved.

The user such as an administrator who manages the operation support system can use the information terminal 13 to refer the utilization status of each help screen based on the utilization status information of various help screens (i.e., help screen utilization status data) stored in the help server 12. Based on the referencing the help screen utilization status data, the user can determine which help screen is not utilized so much, and which help screen is required to be improved. The utilization status of each help screen is also referred to as a referred frequency.

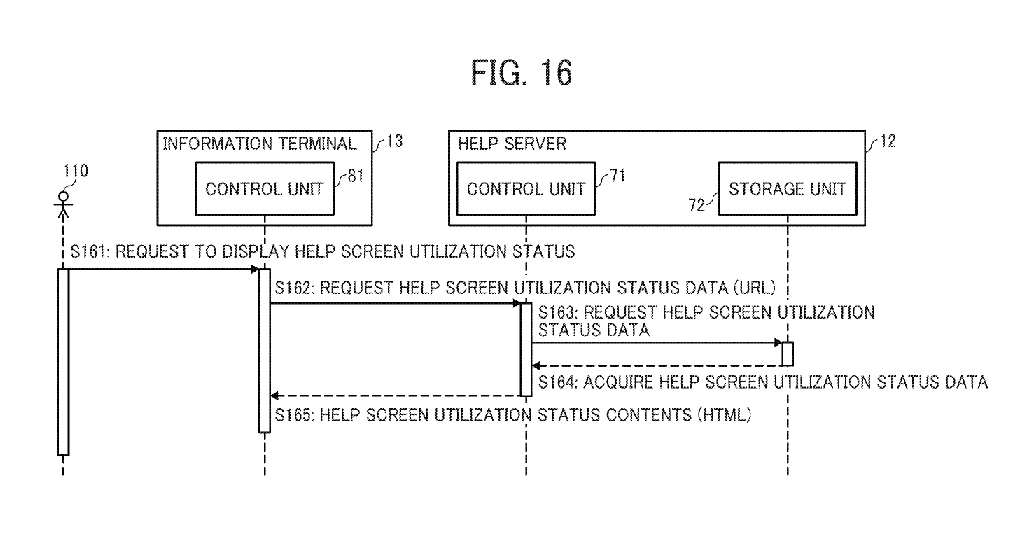

A description is given of processing when the utilization status of the help screen is checked with reference to FIG. 16, which illustrates an example of a sequence of referring the utilization status of the help screens (i.e., referred frequency). In this example case, a user uses the information terminal 13 to acquire various help screen utilization status data stored in the help server 12 and to display the various help screen utilization status data by using the information terminal 13. The various help screen utilization status data stored in the help server 12 is, for example, HTML data, and the information terminal 13 can be installed with a browser used for displaying the HTML data.

In the sequence of FIG. 16, the user 110 (e.g., administrator) requests the information terminal 13 to display the utilization status of the help screen (S161 in FIG. 16).

When the control unit 81 of the information terminal 13 receives the request via the input reception unit 82, the control unit 81 of the information terminal 13 requests the help server 12 to acquire the help screen utilization status data from the help server 12 via the communication unit 80 (S162 in FIG. 16), in which the request includes URL indicating a location storing the help screen utilization data.

When the control unit 71 of the help server 12 receives the request from the information terminal 13 via the communication unit 70, the control unit 71 refers to the URL included in the request, and then requests the help screen utilization status data, corresponding to the URL, to the storage unit 72 (S163 in FIG. 16).

Then, the control unit 71 acquires the corresponding help screen utilization status data from the storage unit 72 (S164 in FIG. 16).

Then, the control unit 71 transmits the acquired help screen utilization status data to the information terminal 13, which has requested the help screen utilization status data to the help server 12, as help screen utilization status contents (S165 in FIG. 16). The help screen utilization status contents is, for example, HTML data.

Then, the control unit 81 of the information terminal 13 acquires the help utilization status contents via the communication unit 80, and instructs the display unit 83 to display the help screen utilization status contents.

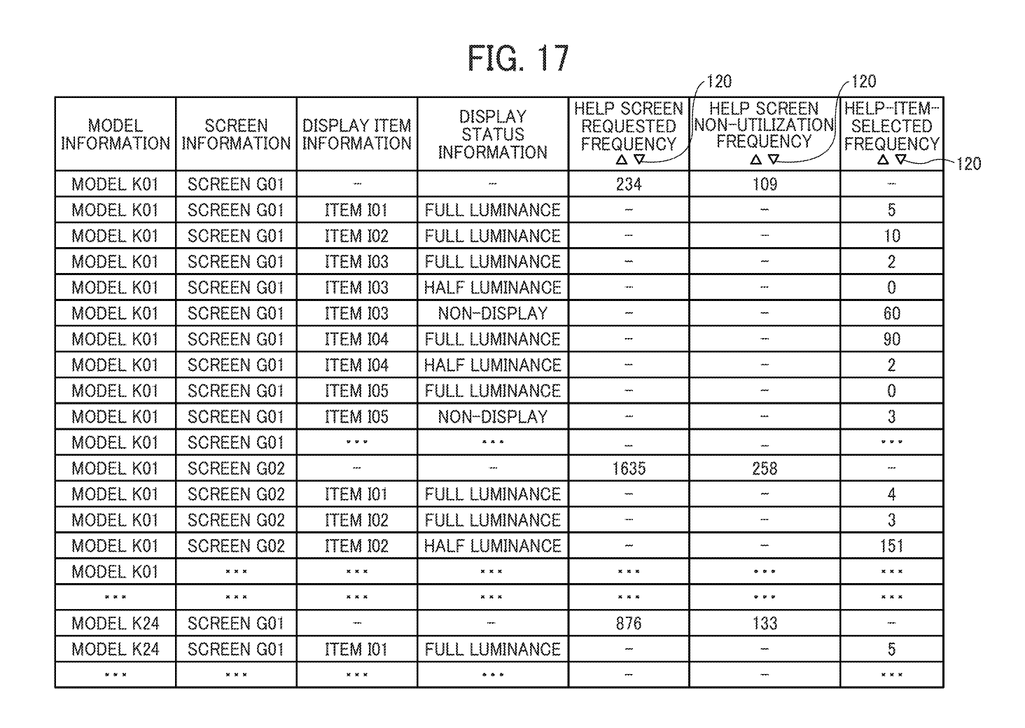

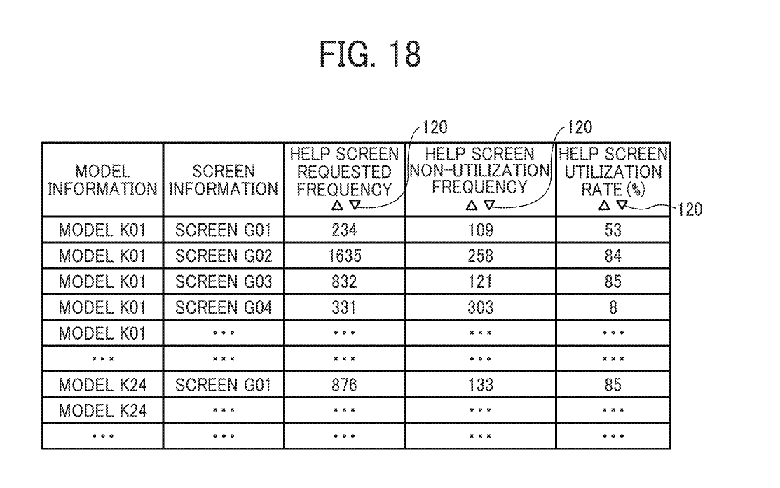

FIGS. 17 and 18 illustrate examples of the help screen utilization status contents displayed by using the display unit 83 of the information terminal 13. FIG. 17 illustrates an example of the help screen utilization status contents displaying all of detailed data of the help screen utilization status. As illustrated in FIG. 17, the help screen utilization status contents includes, for example, the model information, screen information, display item information, display status information, help screen requested frequency, help screen non-utilization frequency, and help-item-selected frequency. Since these information are already described, the description thereof is omitted.

As illustrated in FIG. 17, an ascending/descending button 120 is set for the help screen requested frequency, help screen non-utilization frequency, and help-item-selected frequency, in which data can be arranged in the descending order or the ascending order of the number of counts or frequency by using the ascending/descending button 120. By pressing the ascending/descending button 120, data can be rearranged in any one of the descending order and the ascending order, and then the data can be utilized for analysis or the like. Since the ascending/descending button 120 is provided as one example of functions, other functions can be provided.

FIG. 18 illustrates an example of the help screen utilization status contents displaying data of each screen. Since the detailed data is displayed in FIG. 17, when the display items and the display status are different for the same screen information, the different display items and the different display status are displayed as the display target in FIG. 17. By contrast, since data of the help screen utilization status is displayed for each screen in FIG. 18, the help screen requested frequency and the help screen non-utilization frequency alone are displayed.

In an example illustrated in FIG. 18, the help screen utilization frequency can be acquired by subtracting the help screen non-utilization frequency from the help screen requested frequency, and then the acquired help screen utilization frequency is divided by the help screen requested frequency and multiplied by 100 to acquire a help screen utilization rate (%), which is included in the table of FIG. 18. For example, when a user refers to the help screen utilization rate, the user can recognize that the utilization rate of the screen G04 is significantly lower than the utilization rate of other screens, and the screen G04 may not be utilized so much, and thereby screen G04 may be required to be improved.

As described above, the help screen that is useful for estimating the status of the target machine based on the display contents information and the display status information, and useful for solving the problem corresponding to the currently-displayed screen can be dynamically configured and provided in the operation support system, with which the appropriate help screen can be easily acquired. In this case, the cause of a specific problem can be determined by identifying the setting items in the target machine and acquiring the relevant setting contents as needed, and then a detailed solution for the specific problem can be provided to the user. Further, since the setting contents can be changed in the help screen, the setting change that is required for solving the specific problem can be performed on the help screen.

Further, since the setting contents is not required to be acquired from the help server 12, but the setting contents can be acquired inside the target machine, personal information or the like does not leak on the network 11, with which the operation can be supported while ensuring the information security. Then, by preferentially displaying the help items in the help screen with the priority order of the help screen utilization rate (i.e., from higher to lower help screen utilization rate), a time length for solving the specific problem can be shortened.

Further, since the user can check the help screen utilization status by using the information terminal 13, information identifying a screen layout design that is required to be improved, and information identifying a layout design of the help item in the screen that is required to be improved can be provided to the user. With this configuration, a help screen not including the help item required for the user can be easily identified, and then the help screen can be improved efficiently.

The above described embodiment of the system, apparatus, method, and program can easily acquire appropriate operation support information from a plurality of operation support information to support a user operation on the machine such as an electronic apparatus.

The above described embodiment is applied to the operation support system, the electronic apparatus, the information providing apparatus, the operation support method, and the program. However, the present invention is not limited to the above described embodiment, but numerous additional modifications and variations for the operation support system, the electronic apparatus, information providing apparatus, the operation support method, and the program, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of present disclosure and appended claims. Therefore, a method executed by the electronic apparatus, a method executed by the information providing apparatus, a storage or carrier medium storing the program, and a server for providing the program can be provided.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above described image processing method performable in the image processing apparatus can be described as a computer-executable program, and the computer-executable program can be stored in a ROM or the like in the image processing apparatus and executed by the image processing apparatus. Further, the computer-executable program can be stored in a storage medium or a carrier such as compact disc-read only memory (CD-ROM), digital versatile disc-read only memory (DVD-ROM) or the like for distribution, or can be stored on a storage on a network and downloaded as required.

What is claimed is:

1. An operation support system for supporting one or more operations performable on a machine, comprising:
circuitry to
receive, from the machine, an operation support request for the machine, and information of one or more display items and display status of the one or more display items displayed on a display of the machine;
store a plurality of operation support information for supporting the one or more operations performable on the machine in a memory, the operation support information to be determined by the information of the one or more display items and the display status of the one or more display items;
select at least one operation support information from the memory based on the information of the one or more display items and the display status of the one or more display items received from the machine; and
generate screen information of an operation support screen to be displayed on the display of the machine by using the selected at least one operation support information.

2. The operation support system of claim 1, further comprising other circuitry to acquire setting contents, related to the one or more display items and the display status, set in the machine using the at least one operation support information included in the screen information of the operation support screen,
wherein the other circuitry updates the screen information of the operation support screen based on the acquired setting contents.

3. The operation support system of claim 2, wherein the other circuitry receives a change of the setting contents.

4. The operation support system of claim 3,
wherein the other circuitry changes the screen information of a display screen including the one or more display items based on the change of the setting contents received by the other circuitry,
wherein the other circuitry changes the screen information of the display screen before closing the operation support screen displayed on the display of the machine.

5. The operation support system of claim 1,
wherein the memory further stores a referred count of each of one or more operation support items included in the operation support screen, the referred count indicating the number of times of selecting and referring each of the operation support items,
wherein the circuitry determines a display order of the operation support items in the operation support screen based on the referred count stored in the memory.

6. The operation support system of claim 1,
wherein the memory further stores a referred frequency indicating the number of times of referring the operation support screen displayed on the display of the machine in response to the operation support request for the operation support screen, the operation support screen including a plurality of operation support screens,
wherein when the circuitry receives an acquisition request of the referred frequency, the circuitry provides the referred frequency of each of the plurality of the operation support screens stored in the memory to the machine.

7. The operation support system of claim 1, wherein the memory further stores the number of times of closing the operation support screen displayed on the display of the machine without selecting the operation support item included in the operation support screen.

8. The operation support system of claim 1,
wherein the circuitry further receives model information of the machine, and the screen information of the display screen including the one or more display items of the machine, the model information of the machine including a plurality of model information of a plurality of machines, and the screen information of the display screen including a plurality of screen information,
wherein the memory stores each of the plurality of operation support information in association with each of the plurality of model information and the plurality of screen information of the display screen,
wherein the circuitry selects the at least one of the operation support information when the circuitry receives the information of the one or more display items and the display status of the one or more display items, the plurality of model information, and the plurality of screen information of the display screen.

9. The operation support system of claim 2,
wherein the circuitry and the memory are disposed in an information providing apparatus that provides information to the machine, and the other circuitry is disposed in the machine.

10. An information providing apparatus for providing information supporting one or more operations performable on a machine disposed in an operation support system, the information providing apparatus comprising:
a memory to store a plurality of operation support information for supporting one or more operations performable on the machine, the operation support information settable in view of information of one or more display items and display status of the one or more display items; and
circuitry to
receive, from the machine, an operation support request for the machine, and information of one or more display items and display status of the one or more display items displayed on a display of the machine;
select at least one operation support information from the memory based on the information of the one or more display items and the display status of the one or more display items received from the machine; and
generate screen information of an operation support screen to be displayed on the display of the machine by using the selected at least one operation support information.

11. The information providing apparatus of claim 10,
wherein the memory further stores a referred count of one or more operation support items, the referred count indicating the number of times of selecting and referencing each of operation support items included in the operation support screen,
wherein the circuitry determines a display order of the operation support items in the operation support screen based on the referred count stored in the memory.

12. The information providing apparatus of claim 10,
wherein the memory further stores a referred frequency indicating the number of times of referring the operation support screen displayed on the display of the machine in response to the operation support request for the operation support screen, the operation support screen including a plurality of operation support screens,
wherein when the circuitry receives an acquisition request of the referred frequency, the circuitry provides the referred frequency of each of the plurality of the operation support screens stored in the memory to the machine.

13. The information providing apparatus of claim 10, wherein the memory further stores the number of times of closing the operation support screen displayed on the display of the machine without selecting the operation support item included in the operation support screen.

14. The information receiving apparatus of claim 10,
wherein the circuitry further receives model information of the machine, and the screen information of the display screen including the one or more display items of the machine, the model information of the machine including a plurality of model information of a plurality of machines, and the screen information of the display screen including a plurality of screen information,
wherein the memory stores each of the plurality of operation support information in association with each of the plurality of model information and the plurality of screen information of the display screen,
wherein the circuitry selects the at least one of the operation support information when the circuitry receives the information of the one or more display items and the display status of the one or more display items, the plurality of model information, and the plurality of screen information of the display screen.

15. A machine disposed in an operation support system comprising:
circuitry to
transmit an operation support request for the machine, and information of one or more display items and display status of the one or more display items displayed on a display of the machine to an information providing apparatus that is configured to provide information to the machine;
receive, from the information providing apparatus, screen information of an operation support screen, which is generated in the information providing apparatus based on at least one operation support information used for supporting one or more operations performable on the machine, the at least one operation support information is selected based on the information of the one or more display items and the display status of the one or more display items at the information providing apparatus;
acquire setting contents, related to the one or more display items and the display status of the one or more display items, set in the machine using the at least one operation support information included in the screen information of the operation support screen; and
update the screen information of the operation support screen displayed on the display of the machine based on the acquired setting contents.

16. The machine of claim 15, wherein the circuitry receives a change of the setting contents.

17. The machine of claim 16,
wherein the circuitry changes the screen information of a display screen including the one or more display items based on the change of the setting contents received by the circuitry,
wherein the circuitry changes the screen information of the display screen before closing the operation support screen displayed on the display of the machine.
